(19) United States
(12) Patent Application Publication
(10) Pub. No.: US 2015/0323291 A1
(43) Pub. Date: Nov. 12, 2015

(54) BALLISTIC PROTECTIVE MEASURES

(71) Applicant: AIRBUS OPERATIONS GMBH, Hamburg (DE)

(72) Inventors: Gregor Christian ENDRES, Pfaffenhofen (DE); Hans-Jürgen WEBER, Hamburg (DE)

(21) Appl. No.: 14/648,961

(22) PCT Filed: Dec. 4, 2013
(86) PCT No.: PCT/EP2013/075545

§ 371 Date: Jun. 2, 2015

(30) Foreign Application Priority Data
Dec. 4, 2012 (DE) 10 2012 023 753.7

(51) Int. Cl. F41H 5/04; B32B 37/00

(52) U.S. Cl. CPC F41H 5/0471; F41H 5/0478; F41H 5/0457; B32B 37/0076

(57) ABSTRACT

This relates to measures for protection against striking and penetrating objects. To provide ballistic protection measures that are as light and efficient as possible while having a compact design, a ballistic protective component for protection against penetrating foreign objects comprises a first layer and a second layer, which are mutually spaced by an intermediate layer, that together with a plurality of reinforcement elements, form a sandwich component. Further, an intermediate sheet made of core material is arranged in the intermediate layer. At least one sheet is arranged in the intermediate layer. The ballistic protective material is a fibrous sheet material. In another example, the ballistic protective material comprises dilatant material. The reinforcement elements are tensile and compressive resistant and extend from the first to the second layer through the at least one sheet of ballistic protective material, and, in one example, through the at least one intermediate sheet.

This is a continuation of International Application No.: PCT/EP2013/075545, filed Dec. 4, 2013, which application claims priority to German Patent Application No.: 10 2012 023 753.7, filed Dec. 4, 2012, which are incorporated herein by reference in their entirety.

### TECHNICAL FIELD

The present embodiments relate to measures for protecting against penetrating foreign objects, and relates more particularly to a ballistic protective component for protecting against penetrating foreign objects, to a protective device for protecting against penetrating foreign objects and to a method for producing a ballistic protective component, and to the use of a ballistic protective component.

### BACKGROUND

For protecting against penetrating foreign objects, such as projectiles, components are reinforced, respectively provided with additional components in order to, for example, intercept an impacting projectile and prevent it from penetrating, or at least to slow said projectile to such an extent that the destructive effect is largely mitigated. For impacting projectiles and the like, the term “ballistic impact” is also used. Ballistic protective measures are known for example from armour plating of vehicles, for example armoured cars. A further field of use is also, for example, bulletproof or bullet-retarding vests or other safety clothing. However, it has been found that the use of ballistic protective components for example in already existing structures or constructions can lead to undesirably high component weights and large installation-space dimensions.

Therefore, there is a need to provide a ballistic protective measure, which is as light, efficient and compact as possible.

This is achieved by a ballistic protective component, a protective device, a method and a use according to any of the independent claims. Illustrative embodiments are provided in the dependent claims. It should be noted that the features of the embodiments of the devices also apply to embodiments of the method and of the use of the device, and vice versa. In addition, those features, which do not explicitly mention a combination, can also be combined with one another as desired.

### SUMMARY

A ballistic protective component for protecting against penetrating foreign objects is provided that comprises a first layer and a second layer, which are mutually spaced by an intermediate layer and form a sandwich component together with a plurality of reinforcing elements. In addition, at least one intermediate sheet is made of a core material, which is arranged in the intermediate layer. In addition, at least one sheet of ballistic protective material is provided. The ballistic protective material is a fibrous sheet material and is arranged in the intermediate layer. The reinforcing elements can be subjected to tensile loads and to pressure and extend from the first to the second layer through the at least one intermediate sheet and through the at least one sheet of ballistic protective material.

The term “reinforcing elements” refers to structural components and elements within the component which contribute to reinforcing the component, i.e. reinforcing the component in the context of armour for improving the static, i.e. load-dissipating, properties. The reinforcing elements can be provided as separate elements or can also be formed integral with other elements, components, regions etc.

The reinforcing elements connect two functional layers, the reinforcing elements connecting the ballistic protective layer to the supporting-structure layer of the sandwich construction. In this case, the reinforcing elements extend through the at least one ballistic protective layer and thus provide the connecting effect in the surface without significantly impairing the ballistic protective effect of the protective layer. Ballistic protective layers are for example combined to form protective panels. Ballistic protective layers can for example be produced from high-strength plastics fibres. The fibres are for example spun into yarns, and the yarns are processed into woven fabric or interlaid scrims. Ballistic protective layers can also comprise sheets of woven fabric made of high-strength yarns, which are pressed together with foils to form a laminated woven fabric. For example, at least some of the sheets of ballistic protective material consist of fibre webs. The fibre webs can be formed as woven fabric, or also as unstructured interlaid scrims, such as non-woven fabrics or felt structures. The fibre webs can also be formed as interlaid scrims. The ballistic protective material is a highly tearproof protective layer and consists for example of polyamide material/polyamide fibres (PA), or aramid material/aramid fibres, for example Kevlar® fibres from DuPont or Twaron® or Artec®. The fibres can also consist of polyethylene (PE), for example Dyneema® fibres from Royal DSM N.V. or Spectra® fibres. In addition, the fibres can also consist of poly[p-phenylene-benzobisoxazole] (PBO). The term “highly tearproof” relates to fibres which have similar or identical properties to, for example, Kevlar® fibres, for example a tensile strength range of approximately 2500 MPa to approximately 3500 MPa, for example approximately 2800 MPa or approximately 2900 MPa, and a tensile modulus of elasticity range of approximately 50 to approximately 150 GPa, for example approximately 55 to approximately 65 GPa, for example approximately 59 GPa, or approximately 120 to approximately 135 GPa, for example approximately 127 GPa. The sheets of ballistic protective material can also, for example in addition, comprise sheet materials, such as foil inserts that consist of a very tough material, which at least slows a projectile impacting the surface or other materials such as shrapnel from an explosion and which absorbs the movement energy of the projectile or penetrating foreign object at least in part. By forming a sandwich component or sandwich construction, an inherently stable protective component is provided, which as a result can for example be more easily integrated into existing constructions. In this case, the reinforcing elements create the desired composite effect, by the two layers being both mutually spaced and jointly statically effective. The spacing between the first and the second layer is used to provide a ballistic protective material to achieve the desired ballistic protective effect. Since the reinforcing elements penetrate through the ballistic protective layer, both a continuously ballistic protective layer and a continuous composite-component effect are provided. Here, the term “continuous” refers to the surface. In this case, the core material inter alia mutually spaces the first and the second layer and keeps them mutually spaced.

The term “ballistic protective material” refers to materials, or semi-finished products, which are capable of slowing or even stopping an impacting projectile. The impacting projectile is also referred to as a ballistic impact. Owing to the different types of projectile and the devices used therefore, that is to say weapons, different classes are distinguished, which for example are cited in the standard EN1522. The type and design of the ballistic protection is, inter alia, also dependent on the object to be protected and the maximum protection to be obtained. The protection that can be obtained is primarily dependent on the ballistic protective component, which stops or slows the projectile. In addition, the construction by which the ballistic protective layer or the ballistic protective component is held is also responsible for the protective effect or for the measures provided for the application of force. Since a ballistic protective component is provided according to the embodiments, the structural connection of the ballistic protective component is responsible for the protective effect.

The term “foreign object”, or foreign body, more particularly comprises projectiles, which have been launched from a weapon, or also splinters or material fragments, which impact the protective layer or the protective component owing to explosions. The term “foreign object” also includes components, component fragments or material fragments, which are detached during the operation of rapidly rotating parts, for example engine blades or segments of engine blades in turbines, for example aeroplane turbines.

The term “sandwich component” relates to a planar component, which has a multi-layered construction, comprising at least one first and one second sheet, between which a core sheet, also referred to as a core layer, is arranged. The core sheet is used to keep the two outer sheets mutually spaced. As a result, when a force acts vertically on the surface, the two sheets perform different static functions; for example, in the case of a force acting as a compressive force, the layer facing the force, i.e. the closer sheet, forms a region under compressive stress, while the layer facing away from the force, i.e. the more remote sheet, forms a region under tensile stress. To provide the static functions, the intermediate sheet thus has to have a certain thickness. The two outer sheets are connected via the core sheet, according to the embodiment, by the plurality of reinforcing elements, using which the different sheets, i.e. the first layer, the intermediate layer and the second layer, are interconnected in a shear-resistant manner.

The intermediate layer serves to accommodate the ballistic protective material, which, for providing the ballistic protective effect, both has to have a certain flexibility and has to be capable of slowing the impacting energy of the foreign object, for example by converting it into deformation energy or also the targeted destruction of the individual fibres. In other words, the ballistic protective materials are generally not designed per se for a shear-resistant connection in a sandwich construction. The above-mentioned reinforcing elements perform this function.

The protective component is resistant to bending at least such that it is self-supporting. The protective component is, for example, not deformable after the first and the second layer and the intermediate layer comprising the intermediate sheet and the sheet of ballistic protective material comprising the reinforcing elements are interconnected.

The term “self-supporting” refers to the fact that the protective component is capable of supporting its own weight. The term “self-supporting” also refers to the fact that, after curing the matrix material of the reinforcing elements, the protective component keeps its shape and contour during further handling, for example assembly or finishing.

The material of the intermediate sheet is also referred to as core material.

The term “at least one intermediate sheet of core material” comprises the provision of exactly one intermediate sheet. The term also comprises two intermediate sheets, three intermediate sheets, four intermediate sheets, five intermediate sheets, six intermediate sheets, seven intermediate sheets, eight intermediate sheets, nine intermediate sheets or ten intermediate sheets. The term also comprises more than ten intermediate sheets, for example fifteen intermediate sheets, twenty intermediate sheets or thirty intermediate sheets.

The term “at least one layer of ballistic protective material” comprises the provision of exactly one layer. The term also comprises two sheets, three sheets, four sheets, five sheets, six sheets, seven sheets, eight sheets, nine sheets or ten sheets. The term also comprises more than ten sheets, for example fifteen sheets, twenty sheets or thirty sheets.

A ballistic protective component for protecting against penetrating foreign objects is also provided that comprises a first layer and a second layer, which are mutually spaced by an intermediate layer and form a sandwich component together with a plurality of reinforcing elements. In addition, at least one sheet of ballistic protective material is provided. The ballistic protective material comprises dilatant material, and is arranged in the intermediate layer. The reinforcing elements can be subjected to tensile loads and to pressure and extend from the first to the second layer through the at least one sheet of ballistic protective material.

The term “dilatant” relates to a material that shows a larger degree of flexibility in relation with slower bending or otherwise impacting movement forces, and a smaller degree of flexibility in relation with faster bending or otherwise impacting movement forces. For example, the material can bend when applying a slower bending or can be deformed on the surface by a resting hand acting slowly on the surface, whereas upon an impact of an object, such as a ball impinging on the surface, the material does not deform, or deforms at least essentially less than with the slow acting force. In other words, the dilatant material is soft and can be bent with respect to slow movements, such as movements of a wearer or movements for adapting or conforming to rounded base structures. The material provides a low resistance. However, the dilatant material is having a much higher resistance, such us against deformation, bending or even penetrating, with respect to fast impinging objects.

The dilatant properties are provided in one example by a polymer structure provided, such as a fluid inside encapsulating or basic structures. The basic structure can provide one rather large compartment, or a plurality of smaller compartments for receiving the material.

The “dilatant material” is also referred to as a “shear thickening material”, for example a shear thickening fluid as an example for a non-Newtonian fluid. In dilatant materials, viscosity increases with the rate of shear strain applied. For example, shear thickening behaviour occurs when a transition from a stable state of colloidal suspension to a state of flocculation takes place. An essential part of the properties of these systems has to do with surface chemistry of the particles in a dispersion, which is also referred to as colloids.

As an example, an impact protection material sold under the trade-name “D3O”, by D3O Lab, Brighton UK, is provided for the dilatant material as ballistic protective material.

According to one embodiment, at least one intermediate sheet is provided, which is made of a core material. The intermediate sheet is arranged in the intermediate layer. The reinforcing elements also extend through the at least one intermediate sheet.

According to one embodiment, the core material is compressible.

According to a further embodiment, the reinforcing elements are resistant to bending and are connected to the first and the second layer for force transmission.

“Connected” refers to a connection of the reinforcing elements to the first and the second layer, in which force is transmitted between the first and the second layer and the reinforcing element, it being possible more particularly for tensile and compressive forces to be transmitted. The connection can also be referred to as a force-transmitting connection. Depending on the design of the first and the second layer, a moment can also be transmitted, for example a bending moment, i.e. the reinforcing elements can be fastened in the first and/or the second layer in a cantilevered manner. The force-transmitting connection of the reinforcing elements to the layers thus provides a sandwich component having improved static properties.

According to an embodiment, the at least one intermediate sheet is arranged between two adjacent sheets of ballistic protective material.

For example, a plurality of sheets of ballistic protective material is provided. In a further example, a plurality of intermediate sheets made of a core material is provided.

According to one embodiment, the reinforcing elements extend oblique to a layer direction and a layer thickness of the ballistic protective component.

According to a further embodiment, the first and the second layer consist of fibre-reinforced plastics material and/or a metal material. For example, the first and the second layer are both made of fibre-reinforced plastics material. In another example, the first or the second layer is made of fibre-reinforced plastics material, and the other layer is made of a metal material. In a further example, the first and the second layer are made of a metal material. The first and the second layer can also be made of laminates.

In addition to the ballistic protective material, the intermediate layer also comprises an intermediate sheet, which for example has a thickness that is at least twice the thickness of the adjacent sheets of ballistic protective material.

The intermediate sheet can be connected to the adjacent layers over the surface in a shear-resistant manner, for example connected to the ballistic protective material by the reinforcing elements, or bonded to the first or the second layer.

The reinforcing elements are, for example rigidly, connected to the adjacent sheets, for example by the reinforcing elements penetrating the ballistic protective material. In this case, the sheet of ballistic protective material can be displaceable towards the reinforcing elements, or can be rigidly connected to the reinforcing elements at the point of penetration. In the case of oblique extending reinforcing elements, the displaceability in the plate-thickness direction is reduced by the geometric arrangement, i.e. by the oblique members.

The reinforcing elements can be connected to one or more of or even all the sheets of ballistic protective material and can mutually fix these sheets.

The protective component is, for example, provided in a vehicle, for example an aeroplane, a helicopter, a passenger motor vehicle, a bus, a rail-bound vehicle or a watercraft.

The protective component can, for example, also be provided in an engine as engine protection or on a slat, or as protection for tanks that are provided in or on a vehicle, more particularly an aeroplane or helicopter.

According to an embodiment, the reinforcing elements are formed as thread elements and are infiltrated with a cured matrix material.

The term “thread elements” refers for example to twisted monofilaments, for example monofilaments of a fibrous material, for which the terms “thread” or “threads” are also used. The term “thread elements” also refers to non-twisted monofilaments, for example stretched monofilaments. “Thread elements” refer to thin, flexible, linear elements that can be made up of several individual fibres or which can also comprise only one single fibre. The cross-section is for example round, angular or amorphous.

The thread elements form a stitching, which forms a reinforcement when soaked with cured matrix material, which reinforcement connects the intermediate sheet to the adjacent sheets such that the first and the second layer form a sandwich component together with the intermediate layer.

The thread elements can be soaked or impregnated with matrix material, or can also be infiltrated after the thread elements are put in place. The thread elements can consist of a plurality of fibres, for example a fibre bundle.

The reinforcing elements can, as already mentioned, extend oblique to the surface of the protective component or perpendicular thereto. The perpendicular and oblique arrangements can also be combined. The reinforcing elements can be straight, curved or polygonal, a linear path being advantageous for producing the sandwich effect.

The reinforcing elements are designed, for example, as bend-resistant linear elements, which extend in the direction of the thickness of the intermediate layer.

The reinforcing elements are, for example, pins, rods or ribs that are inserted through the sheets. The elements are connected to the individual layers, i.e. more particularly to the first and the second layer, for example by bonding or by matrix material.

The reinforcing elements may comprise metal, polymer or ceramic. The reinforcing elements can also be formed as composite components, for example fibre-reinforced composite components made of a heavy-duty fibre comprising a matrix material. For example, metal pins or ceramic pins, or pins made of carbon-fibre composite plastics material, can be provided.

The reinforcing elements are resistant to bending for example over at least half the thickness of the intermediate layer. Preferably, the reinforcing elements are resistant to bending over the entire thickness of the intermediate layer.

According to a further embodiment, the intermediate sheet of the intermediate layer consists of a foam material.

The foam material can be provided as a bend-resistant sheet material. In this case, the foam material can be adapted to a three-dimensional shape. However, the foam material can also be provided as a flexible and, for example resilient, sheet material that can be adapted to different shapes.

The core material can be a subordinate fibrous interlaid scrim or a woven fabric. Compressibility is preferably provided, the term “compressible” referring to a material that can be compressed under the effect of a force acting perpendicular to the surface, for example to at least a quarter, a third or more than half the thickness.

According to a further embodiment, the intermediate sheet forms a deformation space having a deformation depth, wherein one or more of the sheets of ballistic protective material can deform into the deformation space when a foreign objects impacts said sheets.

The deformation of the sheet(s) of ballistic protective material can be reversible, for example said sheet can deform resiliently, or can be permanent. The deformation space is preferably arranged on one side of the protective layer, which side is remote from a possible firing direction or impact direction, i.e. facing a region to be protected.

In one example, the at least one intermediate sheet made of the compressible core material forms a primary intermediate sheet, at least one secondary intermediate sheet being provided that consists of a non-compressible material. For example, a plurality of intermediate sheets made of the compressible material can be provided. In addition, a plurality of intermediate sheets made of the non-compressible material can be provided.

According to a further embodiment, the sheets of ballistic protective material are provided with a blocking or barrier treatment at least in the region of the reinforcing elements, which treatment prevents the matrix material from penetrating when the reinforcing elements are infiltrated.

The blocking treatment is, for example, a coating that can be applied for example to the entire surface of the ballistic protective material. The blocking treatment can also be a rubber matrix.

In a further embodiment, a plurality of sheets of ballistic protective material is provided.

In a further embodiment, at least ten sheets of ballistic protective material are provided, and the reinforcing elements interconnect the sheets of ballistic protective material.

In a still further embodiment, ballistic material made from fibrous sheet material is provided in combination with ballistic material comprising dilatant material.

A protective device for protecting against penetrating foreign objects is also provided, which comprises a ballistic protective component and a retaining device. The ballistic protective component is held by the retaining device in front of an object or space to be protected. The ballistic protective component is formed according to any of the preceding examples. The protective device is a device selected from the group consisting of i) protective clothing, ii) motor-vehicle armour plating, iii) aircraft armour plating, iv) watercraft armour plating and v) protective furniture.

According to the embodiment, a protective device for protecting against penetrating foreign objects is provided. The protective device comprises a ballistic protective component and a retaining device. The ballistic protective component is connected to the retaining device and is held by the retaining device in front of a region to be protected. The ballistic protective component comprises a first and a second layer that are mutually spaced by an intermediate layer and that form a sandwich component together with a plurality of reinforcing elements. The ballistic protective component also comprises at least one sheet made of ballistic protective material. The ballistic protective material comprises dilatant material, and the ballistic protective material is arranged in the intermediate layer. The reinforcing elements can be subjected to tensile loads and to pressure and extend from the first to the second layer through the at least one sheet of ballistic protective material. Further, the protective device is a device selected from the group consisting of: i) protective clothing, ii) motor-vehicle armour plating, iii) aircraft armour plating, iv) watercraft armour plating, and v) protective furniture.

According to the embodiment, a protective device for protecting against penetrating foreign objects is provided. The protective device comprises a ballistic protective component, and a retaining device. The ballistic protective component is connected to the retaining device and is held by the retaining device in front of a region to be protected. The ballistic protective component comprises a first and a second layer that are mutually spaced by an intermediate layer and that form a sandwich component together with a plurality of reinforcing elements. The ballistic protective component further comprises at least one intermediate sheet made of a core material, which is arranged in the intermediate layer, and at least one sheet made of ballistic protective material. The ballistic protective material is a fibrous sheet material and is arranged in the intermediate layer, and the reinforcing elements can be subjected to tensile loads and to pressure and extend from the first to the second layer through the at least one intermediate sheet and through the at least one sheet of ballistic protective material. Further, the protective device is a device selected from the group consisting of: i) protective clothing, ii) motor-vehicle armour plating, iii) aircraft armour plating, iv) watercraft armour plating, and v) protective furniture.

Protective clothing is understood to mean, more particularly, protective vests, protective inserts and headgear, such as helmets. Vehicles are understood to mean, more particularly, civilian vehicles, for example passenger motor vehicles, cash transport, buses, minibuses etc., and also military vehicles. Vehicles are also understood to mean rail-bound vehicles. Aircraft is understood to mean, more particularly, aeroplanes and helicopters. Protective furniture is understood to mean, more particularly, movable furniture and also built-in furniture, and also partition walls/separating elements.

A method for producing a ballistic protective component is also provided, which comprises the steps of: a) arranging at least one sheet of ballistic protective material that consists of a fibrous sheet material; b) arranging at least one intermediate sheet that consists of a core material; c) arranging a first and a second layer, the at least one intermediate sheet and the at least one sheet of ballistic protective material being arranged between the first and the second layer and forming an intermediate layer; and d) providing a plurality of reinforcing elements that can be subjected to tensile loads and to pressure and that extend from the first to the second layer through the intermediate layer and through the at least one sheet of ballistic protective material, wherein the first layer, the intermediate layer and the second layer form a sandwich component together with the reinforcing elements.

The sequence of the individual steps, more particularly of the steps a), b) and c), can also be different, for example the first or the second layer can first be provided, in order to then provide the one or more sheets of ballistic protective material. The intermediate sheet can also be provided while providing the sheets of ballistic protective material, in order to arrange the intermediate sheet between several sheets of ballistic protective material. Depending on the design of the pins, these can also be provided in between, in order to then slide or push the subsequent layers onto the pins, for example.

In one example, before providing the reinforcing elements, the protective component is shaped and the shape is subsequently fixed. Said fixing can also take place after the reinforcing elements are provided. In another example, the shaping and subsequent fixing of the shape is provided after the reinforcing elements are provided.

A method for producing a ballistic protective component is provided, which comprises the steps of: a) arranging at least one sheet of ballistic protective material that comprises dilatant material; c) arranging a first and second layer, the at least one sheet of ballistic protective material being arranged between the first and second layer and forming an intermediate layer; and d) providing a plurality of reinforcing elements that can be subjected to tensile loads and to pressure and that extend from the first to the second layer through the at least one sheet of ballistic protective material, wherein the first layer, the intermediate layer and the second layer for a sandwich component together with the reinforcing elements.

According to an example, it is further provided: b) arranging at least one intermediate sheet that consists of a core material; wherein in step c), the at least one intermediate sheet and the at least one sheet of ballistic protective material are arranged between the first and the second layer and are forming an intermediate layer; and wherein in step d), the reinforcing elements extend through the intermediate layer.

According to one example, the reinforcing elements are formed as thread elements, and the following further steps are provided: e) infiltrating the thread elements with a curable matrix material; and f) curing the matrix material.

Infiltrating the thread elements can be provided for example before the thread elements are put in place or after the thread elements are put in place.

According to one example, before curing the matrix material, an adaptation to a shape or contour is provided, for example before or after infiltration.

The use of a ballistic protective component according to any of the above-described examples in a protective device is provided, which device is selected from the group consisting of: i) protective clothing, ii) armoured motor vehicles, iii) armoured aircraft, iv) armoured watercraft and v) protective furniture.

The ballistic protective effect of, for example, Kevlar® or Dyneema® fibres are coupled with the excellent lightweight structural properties of a sandwich component. The connection is produced by the reinforcing elements, which connect two different functional layers, specifically the ballistic protective layer and the supporting function of the sandwich construction. As a result, a ballistically reinforced and structurally load-bearing component is provided that requires less installation space in a construction of which the total weight is optimised. Owing to the combination of ballistic woven fabric with a further sheet, for example foam, a laminate can be provided, which largely prevents an impacting projectile from passing through, and at the same time at least reduces, if not completely eliminates, a total deformation, which for example outwardly manifests towards the side to be protected, since the deformation is absorbed inside, i.e. by the further intermediate sheet for example of foam. Owing to the infiltration with a curable material, a composite is produced, which has the mechanical properties of a sandwich component with all the weight advantages, and which, by modifying the core, provides an additional ballistic effect. The different requirements of the various armour-protection classes can thus be met, depending on the construction of the layers of the protective component, while at the same time saving on weight.

### BRIEF DESCRIPTION OF THE DRAWINGS

In the following, embodiments will be described in more detail with reference to the accompanying drawings, in which:

FIG. 1A is a schematic cross-section through an example of a ballistic protective component;

FIG. 1B is a further example of a ballistic protective component;

FIG. 2 is a further example of a ballistic protective component in cross-section;

FIG. 3 is a further example of a ballistic protective component;

FIG. 4 is an example of a ballistic protective component showing a deformation of an inner ballistic protective layer;

FIG. 5 is a detail of a ballistic protective component, in which a reinforcing element is shown in conjunction with a sheet of a ballistic protective material;

FIG. 6 is a schematic cross-section through an example of a protective device for protecting against penetrating foreign objects;

FIG. 7 shows an example of a method for producing a ballistic protective component;

FIG. 8 shows a further example of a method;

FIG. 9 is a perspective view of a detail of a ballistic protective component with a foreign object having penetrated;

FIG. 10 is a photographic representation of the detail from FIG. 9;

FIG. 11 is a schematic cross-section through an example of a ballistic protective component with dilatant material;

FIG. 12 is a further example of a ballistic protective component in cross-section; and

FIG. 13 shows another example of a method for producing a ballistic protective component.

### DETAILED DESCRIPTION

The following detailed description of the embodiment is merely exemplary in nature and is not intended to limit the embodiment or the application and uses of the embodiment. Furthermore, there is no intention to be bound by any theory presented in the preceding background of the embodiment or the following detailed description of the embodiment.

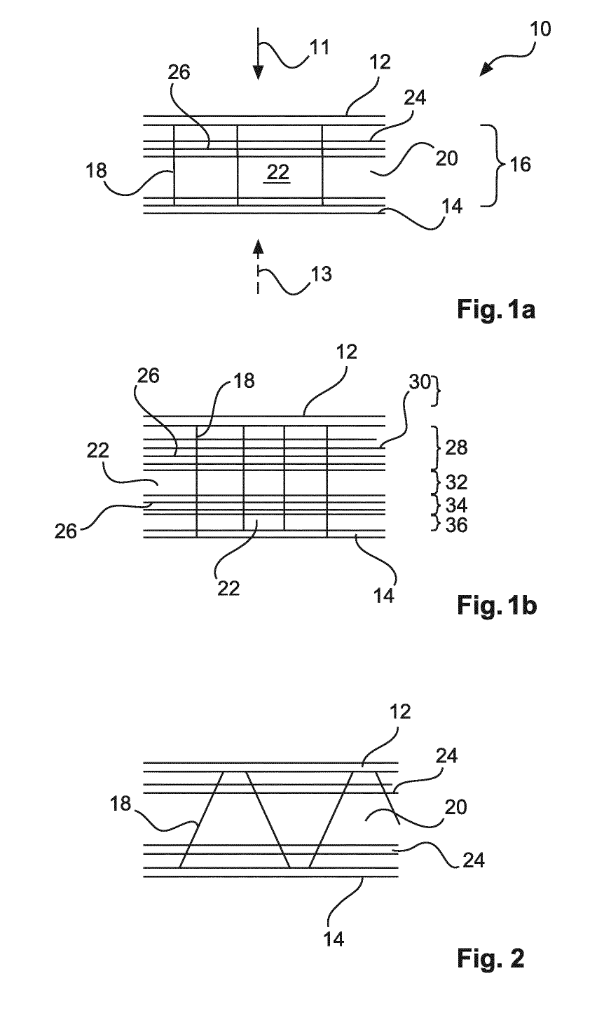

FIG. 1A is a cross-section through a ballistic protective component 10 for protecting against penetrating foreign objects. The ballistic protective component 10 comprises a first layer 12 and a second layer 14, which are mutually spaced by an intermediate layer 16 and form a sandwich component together with a plurality of reinforcing elements 18. In addition, at least one intermediate sheet 20 of a core material 22 is provided that is arranged in the intermediate layer 16. At least one sheet 24 of ballistic protective material 26 is also provided in the intermediate layer 16. The ballistic protective material 26 is a fibrous sheet material and is, as already explained, arranged in the intermediate layer 16. The reinforcing elements 18 can be subjected to tensile loads and to pressure and extend from the first layer 12 to the second layer 14 through the intermediate sheet 20 and through the at least one sheet 24 of ballistic protective material 26.

In order to provide a yet higher static efficacy of the sandwich component, the reinforcing elements 18 can be connected, i.e. connected in a force-transmitting manner, to the two layers 12, 14 such that it is possible to apply force to the reinforcing elements 18 from the layers 12, 14 and vice versa to the layers 12, 14 from the reinforcing elements 18. The force-transmitting connection is produced for example using bonded connections to the contact points or penetration points (not shown in greater detail) of the reinforcing elements to the first and second layer respectively. The connection can also be produced by matrix material that penetrates the first or second layer in the immediate area surrounding the connection point and thus connects the reinforcing elements and the layers in a material connection.

A possible impact direction of a foreign object, for example a projectile or splinter or other material parts, is indicated by an arrow 11. According to a further embodiment (not shown in greater detail), a foreign object can also impact from the other side, as indicated by a further, dashed arrow 13. The different directions can be taken into account by accordingly arranging the ballistic protective layers and the intermediate layers. For example, when viewed in the direction of the projectile, a ballistic protective layer can initially be provided, followed by an intermediate layer, in order to ensure, for example, a deformation into this region. This can also be further improved by multiple sequential layer arrangements. For example, at least ten sheets of ballistic protective material are provided, the reinforcing elements connecting the sheets of ballistic material to one another and also to the first and the second layer 12, 14.

The possible directions of impacting projectiles are not shown in greater detail in the following drawings, since these circumstances are easily comprehensible and conceivable.

FIG. 1B shows an embodiment, in which a first stack 28 of a plurality of sheets 30 of ballistic protective material 26 is provided between the first layer 12 and the second layer 14, the individual layers, unlike FIG. 1A, being shown merely as lines and not with respective double lines. A first sheet 32 of the core material 22 is then provided, followed by a second stack 34 of several sheets of the ballistic protective material 26. A second sheet 36 of the core material 22 is provided between said further stack 34 and the second layer 14.

According to further embodiments, different layer sequences of the ballistic protective material 26 and the core material 22 are provided between the two outer layers, i.e. the first layer and the second layer.

In the embodiments described, the reinforcing elements 18 extend through the ballistic protective layers, i.e. the sheets of ballistic protective material 26.

The ballistic protective material 26 comprises fibre webs made of ballistic protective material, for example made of highly tearproof fibres, for example made of aramid fibres such as Kevlar® fibres or Dyneema® fibres. The fibre webs can be formed for example as woven fabric, or also as unstructured interlaid scrims, such as non-woven fabrics or felt structures.

As shown in FIG. 2, in an example, the reinforcing elements 18 extend oblique. The reinforcing elements are resistant to bending and are connected to the first and the second layer 12, 14 in a force-transmitting manner. The core material 22 is, for example, compressible. As also shown in FIG. 2, the at least one intermediate sheet 20 can be arranged between two adjacent sheets 24 of ballistic protective material 26.

The first layer 12 and the second layer 14 is comprised, for example, of fibre-reinforced plastics material or a metal material. The first layer 12 and the second layer 14 can for example be formed as fibrous materials that are embedded in a matrix, the matrix being cured, for example.

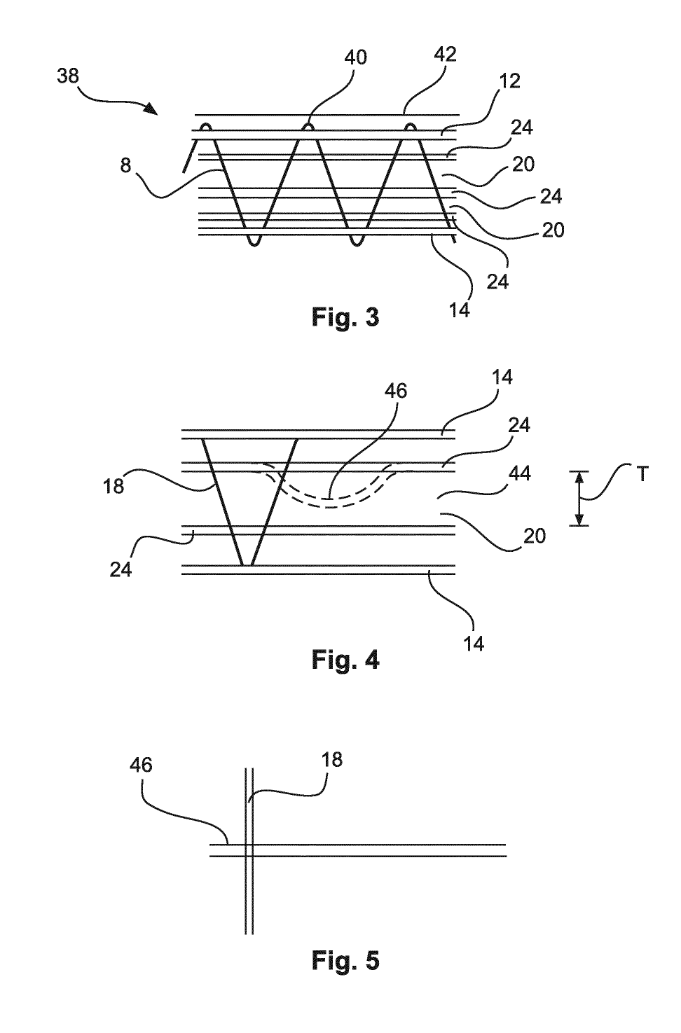

FIG. 3 shows a further embodiment, in which the reinforcing elements 18 are formed as thread elements 38. For example, the reinforcing elements 18 can be produced as stitching, and this can be seen by the loop formations 40 on the first and the second layer 12, 14. The thread elements are infiltrated with a cured matrix material.

According to a further example (not shown), the reinforcing elements 18 are formed as bend-resistant linear elements, for example as pins, rods or ribs inserted through the sheets.

In FIG. 3, a further cover layer 42 is arranged on the first layer 12, for example a layer that forms the visible surface and protects against moisture and other environmental influences, such as UV radiation. The layer 42 can for example also have acoustic properties, for example for sound absorption.

It should be noted that the additional cover layer 42 is also provided for the other embodiments shown, and can also be provided as an additional surface layer on the second layer 14.

FIG. 4 shows an embodiment, in which the intermediate sheet 20 forms a deformation space 44 having a deformation depth T, such that one or more of the sheets 24 of ballistic protective material 26 can deform into the deformation space 44 when a foreign object, for example a projectile, impacts said sheets. This is indicated by a dashed line 46.

FIG. 5 shows an embodiment, in which the sheets of ballistic protective material, only one sheet 24 being shown in FIG. 5, are provided with a blocking treatment 46 at least in the region of the reinforcing elements 18, which treatment prevents the matrix material from penetrating when the reinforcing elements 18 are infiltrated. The blocking treatment is for example a coating or a rubber matrix. It is thereby ensured that, despite the reinforcement, the sheets of ballistic protective material 26 maintain the required properties in respect of flexibility and deformability and of converting the impacting kinetic energy into deformation or destruction energy. Complete infiltration of the ballistic protective material would reduce the ballistic protective effect thereof.

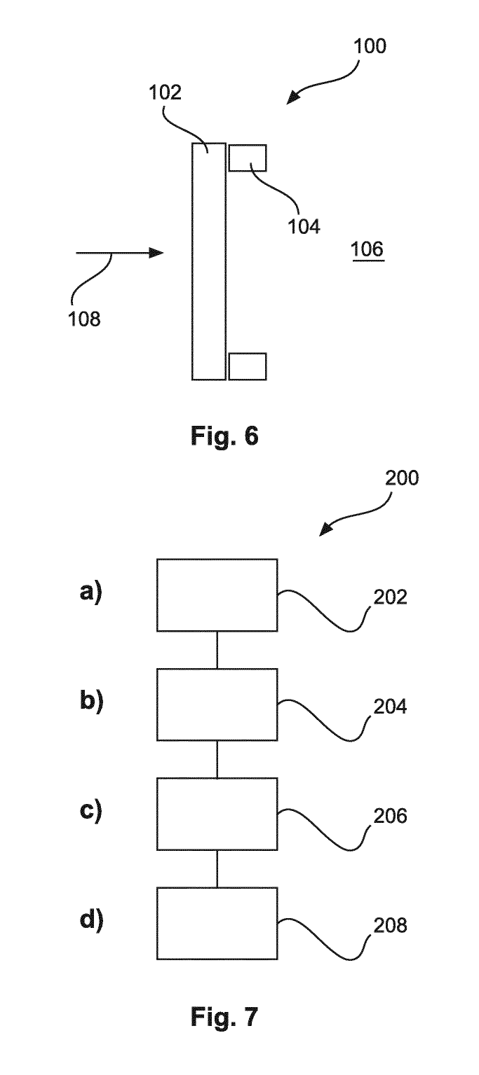

FIG. 6 is a schematic cross-section through a protective device 100, in which a ballistic protective component 102 and a retaining device 104 are provided. The ballistic protective component 102 is connected to the retaining device 104 and is held by the retaining device in front of a region 106 to be protected. The ballistic protective component 102 is formed according to any of the above-described examples of the ballistic protective component 10. The direction of a potentially impacting foreign object is indicated by an arrow 108. The protective device is, for example, protective clothing, motor-vehicle armour plating, aircraft armour plating, watercraft armour plating or protective furniture, the respective surrounding structures not being shown in greater detail.

FIG. 7 shows the most important, or basic, steps of an example of a method 200 for producing a ballistic protective component.

In a first step 202, at least one sheet of ballistic protective material that consists of a fibrous sheet material is arranged.

In a second step 204, at least one intermediate sheet that consists of a core material is arranged.

In a third step 206, a first and a second layer are arranged, the at least one intermediate sheet and the at least one sheet of ballistic protective material from the first and the second step 202, 204 being arranged between the first and the second layer and forming an intermediate layer.

In a fourth step 208, a plurality of reinforcing elements that can be subjected to tensile loads and to pressure and that extend from the first to the second layer through the intermediate layer and through the at least one layer of ballistic protective material is provided. Here, the first layer, the intermediate layer and the second layer form a sandwich component together with the reinforcing elements.

The first step 202 is also referred to as step a), the second step 204 as step b), the third step 206 as step c) and the fourth step 208 as step d).

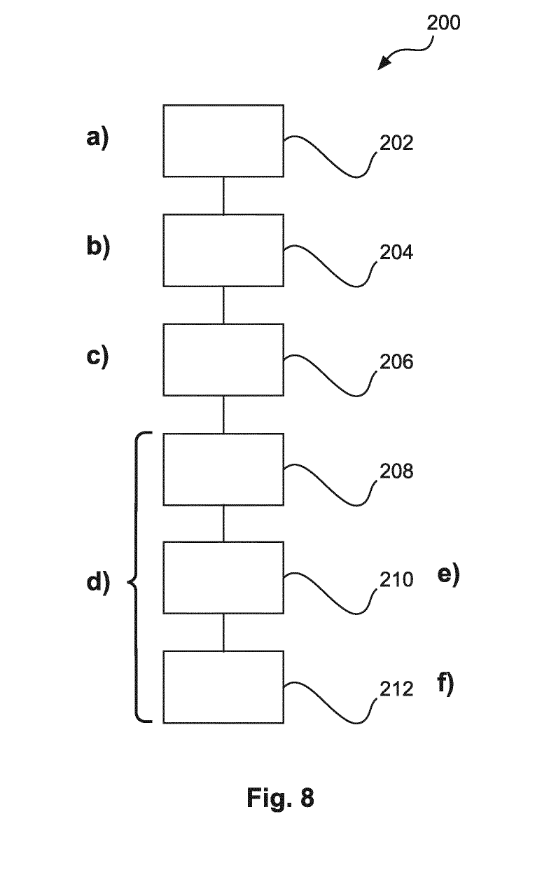

FIG. 8 shows a further embodiment of a method, in which the reinforcing elements are formed as thread elements and in which the following is further provided infiltrating 210 the thread elements with a curable matrix material, and curing 212 the matrix material.

The infiltrating 210 is also referred to as step e), and the curing 212 as step f). FIG. 8 shows that, in this example, step d) includes the providing in step 208 as well as the infiltrating 210 and the curing 212. For example, an adaptation (not shown in greater detail) to a shape or contour is provided before the curing 212 of the matrix material.

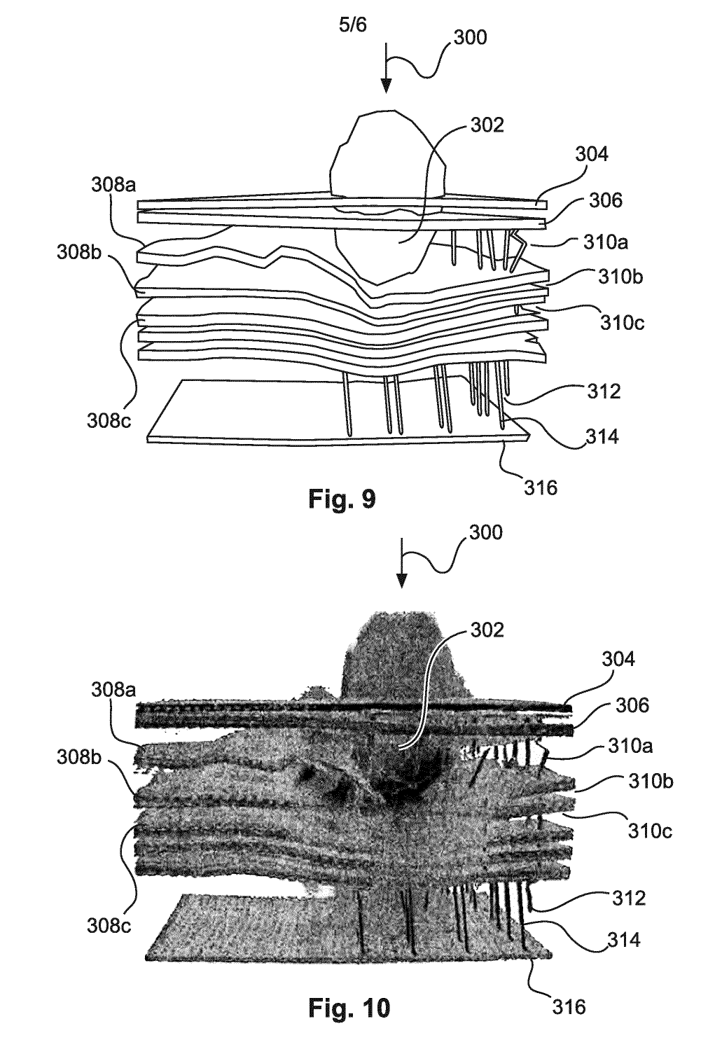

FIG. 9 is a perspective view of a detail or cross-section of a protective device according to the embodiment in the case of a projectile having impacted.

An arrow 300 indicates the impact direction of a projectile 302. The projectile has penetrated an outer cover sheet 304 and a first layer 306 and the impact thereof has passed through several sheets of ballistic protective material, denoted by 308a, 308b, 308c etc. The projectile 302 has for example penetrated the first sheet 308a of ballistic protective material and has deformed the second sheet 308b. For example, intermediate sheets of a core material, for example foam materials, are provided between the sheets of ballistic protective material, which is indicated by reference signs 310a, 310b, 310c etc. On the underside (in relation to the representation in the figure), a further sheet 312 of core material is provided in order to provide a deformation space. Finally, this is followed by yet another layer 316, which is connected to the first layer 306 via a plurality of reinforcing elements 314. In addition, another outer cover sheet or finishing layer can be provided (not shown in greater detail).

In the immediate region of impact, i.e. in the upper layers, the reinforcing elements 314 are destroyed, i.e. demolished, in part. Owing to this targeted destruction, a further amount of kinetic energy can be converted or absorbed in order to thus provide ballistic protection.

With respect to the representation in FIG. 9, it should be noted that the representation is based on a computed tomography X-ray image, using which the individual layers and the deformation thereof within the protective component can be spatially displayed. Owing to the X-ray technology used, the intermediate layers of core material cannot be seen.

In FIG. 10, the representation from FIG. 9 is shown as a photographic image, more specifically as the image used for the computed tomography examination. Since the same reference signs are used, FIG. 10 is not discussed in greater detail.

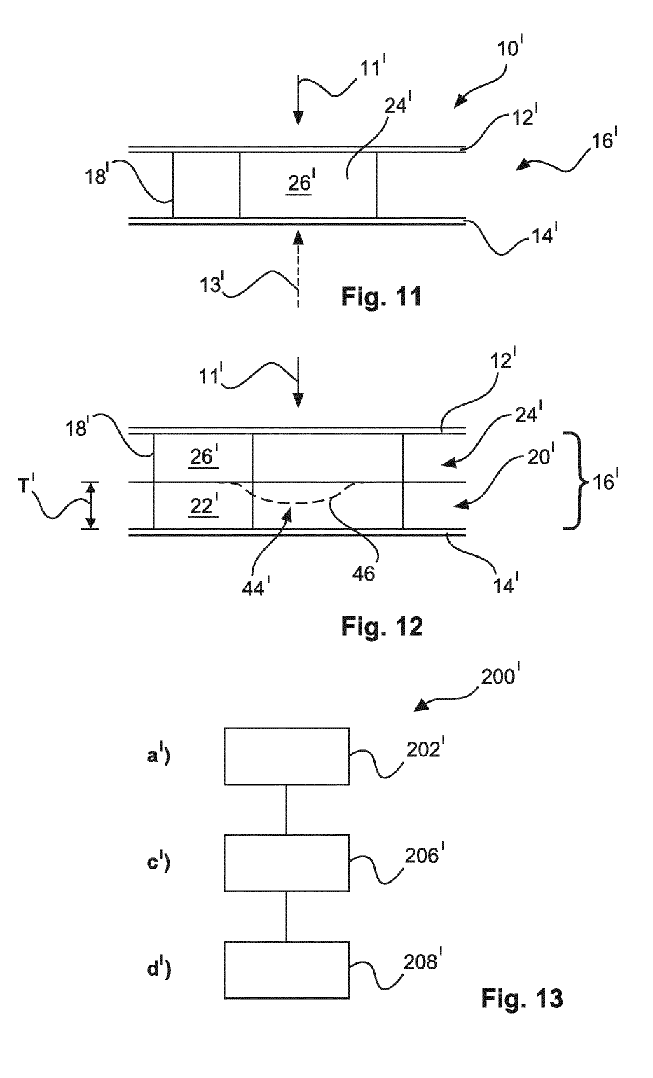

It is noted that in the following, further examples for the ballistic protective material are described with reference to FIGS. 11 and 12. Whereas a fibrous sheet material for the ballistic protective material has been discussed above, in the following a ballistic protective material 26′ is provided. The ballistic protective material 26′ is a dilatant material.

FIG. 11 is a cross-section of a further embodiment of a ballistic protective component 10′ for protecting against penetrating foreign objects. The ballistic protective component 10′ comprises a first layer 12′ and a second layer 14′, which are mutually spaced by an intermediate layer 16′ and which form a sandwich component together with a plurality of reinforcing elements 18′. In addition, at least one sheet 24′ of the ballistic protective material 26′ is provided in the intermediate layer 16′. The reinforcing elements 18′ can be subjected to tensile loads and to pressure and extend from the first layer 12′ to the second layer 14′ through the at least one sheet 24′ of the ballistic protective material 26′.

A possible impact direction of a foreign object is indicated by an arrow 11′, but, as above, a foreign object can also impact from the other side, as indicated by a further, dashed arrow 13′.

FIG. 12 shows another embodiment of the ballistic protective component 10′ of FIG. 11. At least one intermediate sheet 20′ of a core material 22′ is provided that is arranged in the intermediate layer 16′. The reinforcing elements 18′ extend from the first layer 12′ to the second layer 14′ through the intermediate sheet 20′, and through the at least one sheet 24′ of the ballistic protective material 26′.

In one example, the intermediate sheet 20′ forms a deformation space 44′ having a deformation depth T′, such that one, or more of the sheets 24′ of the ballistic protective material 26′ can deform into the deformation space 44′ when a foreign object, for example a projectile, impacts said sheets. This is indicated by a dashed line 46′.

In an example, the core material 22′ is compressible, for example for providing the deformation space 44′.

Further, the examples above, relating to the dilatant material for the ballistic protective material, are provided also in combination with the above-mentioned examples.

For example, with respect to the dilatant ballistic protective material, the reinforcing elements are resistant to bending, and the reinforcing elements are connected to the first and the second layer. In another example, the at least one intermediate sheet is arranged between two adjacent sheets made of the ballistic protective material. In another example, the reinforcing elements are extending oblique to a layer direction and a layer thickness. In a further example, the reinforcing elements are formed as thread elements, and the thread elements are infiltrated with a cured matrix material. In another example, the first and the second layer consist of fibre-reinforced plastics material and/or a metal material. In another example, the intermediate sheet consists of a foam material. In another example, the sheets of ballistic protective material are provided with a blocking treatment at least in the region of the reinforcing elements. The blocking treatment prevents the matrix material from penetrating when the reinforcing elements are infiltrated.

In a further embodiment, not further shown, ballistic material made from fibrous sheet material is provided in combination with ballistic material comprising dilatant material.

FIG. 13 shows steps of an example of a method 200′ for producing a ballistic protective component:

In a step 202′, at least one sheet of ballistic protective material that comprises dilatant material is arranged.

In a next step 206′, a first and a second layer are arranged, the at least one sheet of ballistic protective material from the first and the second step 202′ being arranged between the first and the second layer and forming an intermediate layer.

In a further step 208′, a plurality of reinforcing elements that can be subjected to tensile loads and to pressure and that extend from the first to the second layer through the at least one layer of ballistic protective material is provided. The first layer, the intermediate layer and the second layer form a sandwich component together with the reinforcing elements.

The step 202′ is also referred to as step a′), the next step 206′ as step c′), and the further step 208′ as step d′).

The embodiments described above can be combined in different ways. In particular, aspects of the devices can also be used for embodiments of the method and for the use of the devices and vice versa.

In addition, it should be noted that “comprising” does not exclude any other elements or steps and that “a” or “an” does not exclude a plurality. It should further be noted that features or steps which have been described with reference to one of the above embodiments may also be used in combination with other features or steps of other embodiments or developments disclosed above. Reference signs in the claims are not to be considered to be limiting.

While at least one exemplary embodiment has been presented in the foregoing detailed description of the embodiment, it should be appreciated that a vast number of variations exist. It should also be appreciated that the exemplary embodiment or exemplary embodiments are only examples, and are not intended to limit the scope, applicability, or configuration of the embodiment in any way. Rather, the foregoing detailed description will provide those skilled in the art with a convenient road map for implementing an exemplary embodiment of the embodiment, it being understood that various changes may be made in the function and arrangement of elements described in an exemplary embodiment without departing from the scope of the embodiment as set forth in the appended claims and their legal equivalents.

1. A ballistic protective component for protecting against penetrating foreign objects, comprising:
a first and a second layer that are mutually spaced by an intermediate layer and that form a sandwich component together with a plurality of reinforcing elements;
at least one intermediate sheet made of a core material, which is arranged in the intermediate layer, and
at least one sheet made of ballistic protective material;
wherein the ballistic protective material is a fibrous sheet material and is arranged in the intermediate layer; and
wherein the reinforcing elements can be subjected to tensile loads and to pressure and extend from the first to the second layer through the at least one intermediate sheet and through the at least one sheet of ballistic protective material.

2. A ballistic protective component for protecting against penetrating foreign objects, comprising:
a first and a second layer that are mutually spaced by an intermediate layer and that form a sandwich component together with a plurality of reinforcing elements; and
at least one sheet made of ballistic protective material;
wherein the ballistic protective material comprises dilatant material, and wherein the ballistic protective material is arranged in the intermediate layer; and
wherein the reinforcing elements can be subjected to tensile loads and to pressure and extend from the first to the second layer through the at least one sheet of ballistic protective material.

3. Ballistic protective component according to claim 2,
further comprising at least one intermediate sheet made of a core material, which is arranged in the intermediate layer;
wherein the reinforcing elements extend through the at least one intermediate sheet.

4. Ballistic protective component according to claim 1, wherein the core material is compressible.

5. Ballistic protective component according to claim 1, wherein the reinforcing elements are resistant to bending; and
wherein the reinforcing elements are connected to the first and the second layer.

6. Ballistic protective component according to claim 1, wherein the at least one intermediate sheet is arranged between two adjacent sheets made of ballistic protective material.

7. Ballistic protective component according to claim 1, wherein:
the reinforcing elements extend oblique to a layer direction and a layer thickness; and/or
the reinforcing elements are formed as thread elements, wherein the thread elements are infiltrated with a cured matrix material.

8. Ballistic protective component according to claim 1, wherein the first and the second layer consist of fibre-reinforced plastics material and/or a metal material.

9. Ballistic protective component according to claim 1, wherein the intermediate sheet consists of a foam material.

10. Ballistic protective component according to claim 1, wherein the intermediate sheet forms a deformation space having a deformation depth; and
wherein one or more of the sheets of ballistic protective material can deform into the deformation space when a foreign object impacts said sheets.

11. Ballistic protective component according to claim 1, wherein the sheets of ballistic protective material are provided with a blocking treatment at least in the region of the reinforcing elements, which blocking treatment prevents the matrix material from penetrating when the reinforcing elements are infiltrated.

12. (canceled)

13. (canceled)

14. A method for producing a ballistic protective component, which comprises the steps of:
a) arranging at least one sheet of ballistic protective material that comprises dilatant material;
c) arranging a first and a second layer, the at least one sheet of ballistic protective material being arranged between the first and the second layer and forming an intermediate layer; and
d) providing a plurality of reinforcing elements that can be subjected to tensile loads and to pressure and that extend from the first to the second layer through the at least one sheet of ballistic protective material;
wherein the first layer, the intermediate layer and the second layer form a sandwich component together with the reinforcing elements.

15. Method according to claim 14, wherein it is further provided:
b) arranging at least one intermediate sheet that consists of a core material;
wherein in step c), the at least one intermediate sheet and the at least one sheet of ballistic protective material are arranged between the first and the second layer and are forming an intermediate layer; and
wherein in step d), the reinforcing elements extend through the intermediate layer.

16. (canceled)

17. (canceled)

18. (canceled)

19. Ballistic protective component according to claim 3, wherein the core material is compressible.

20. Ballistic protective component according to claim 2, wherein the reinforcing elements are resistant to bending; and
wherein the reinforcing elements are connected to the first and the second layer.

21. Ballistic protective component according to claim 2, wherein the at least one intermediate sheet is arranged between two adjacent sheets made of ballistic protective material.

22. Ballistic protective component according to claim 2, wherein:
the reinforcing elements extend oblique to a layer direction and a layer thickness; and/or
the reinforcing elements are formed as thread elements, wherein the thread elements are infiltrated with a cured matrix material.

23. Ballistic protective component according to claim 2, wherein the first and the second layer consist of fibre-reinforced plastics material and/or a metal material.

24. Ballistic protective component according to claim 2, wherein the intermediate sheet consists of a foam material.

25. Ballistic protective component according to claim 2, wherein the intermediate sheet forms a deformation space having a deformation depth; and
wherein one or more of the sheets of ballistic protective material can deform into the deformation space when a foreign object impacts said sheets.
